(19) United States
(12) Patent Application Publication
(10) Pub. No.: US 2020/0045352 A1
(43) Pub. Date: Feb. 6, 2020

(54) SYSTEM AND PROCESS FOR GENERALIZED REAL-TIME TRANSPORT PROTOCOL STREAM SEGMENTATION AND RECONSTRUCTION

(71) Applicant: IMAGINE COMMUNICATIONS CORP., North York (CA)

(72) Inventors: Brick EKSTEN, Uxbridge (CA); Leigh WHITCOMB, Toronto (CA); John Norman MAILHOT, Bridgewater, NJ (US)

(21) Appl. No.: 16/530,413

(22) Filed: Aug. 2, 2019

Related U.S. Application Data
(60) Provisional application No. 62/713,872, filed on Aug. 2, 2018.

(51) Int. Cl. H04N 21/24; H04L 12/26; H04L 12/727

(52) U.S. Cl. CPC H04N 21/2402; H04N 21/2407; H04L 61/2007; H04L 45/121; H04L 43/0894

(57) ABSTRACT

There is provided a network device comprising at least one processor, and a memory storing instructions which when executed by the at least one processor configure the processor to perform a method. The method comprises segmenting packets of an original data stream into at least two partial data streams, and transmitting the at least two partial data streams to a downstream receiver configured to consolidate the at least two partial data streams based on the sequence numbers of the original data stream to reconstruct the original data stream. Each of the at least two partial data streams has an identifier in a header. The at least two partial data streams maintain sequence numbers of the original data stream.

### CROSS-REFERENCE TO RELATED APPLICATIONS

This application claims all benefit including priority to U.S. Provisional Patent Application 62/713,872, filed Aug. 2, 2018, and entitled: “SYSTEM AND PROCESS FOR GENERALIZED REAL-TIME TRANSPORT PROTOCOL STREAM SEGMENTATION AND RECONSTRUCTION,” which is hereby incorporated by reference in its entirety.

### FIELD

The present disclosure generally relates to the field of delivering data over networks.

### INTRODUCTION

Embodiments described herein relate to network protocols for media (e.g., audio and video). For example, Real-time Transport Protocol (RTP) is a network protocol for delivering audio and video over IP networks. RTP can be for end-to-end, real-time, transfer of streaming media. There are cases, particularly in ultra-high-definition television (UHD) production, where the required bit-rate of an RTP stream is larger than the available capacity of the individual network links available to carry it. Systems used in production can have more than one link available.

### SUMMARY

In accordance with an embodiment, there is provided a network device. The network device comprises at least one processor, and a memory storing instructions which when executed by the at least one processor configure the processor to segment packets of an original data stream into at least two partial data streams, and transmit the at least two partial data streams to a downstream receiver configured to consolidate the at least two partial data streams based on the sequence numbers of the original data stream to reconstruct the original data stream. Each of the at least two partial data streams have an identifier in a header. The at least two partial data streams maintain sequence numbers of the original data stream.

In accordance with another embodiment, there provided a computer-implemented method comprising at least one processor segmenting packets of an original data stream into at least two partial data streams, and transmitting the at least two partial data streams to a downstream receiver configured to consolidate the at least two partial data streams based on the sequence numbers of the original data stream to reconstruct the original data stream. Each of the at least two partial data streams has an identifier in a header. The at least two partial data streams maintain sequence numbers of the original data stream.

In accordance with another embodiment, there provided a network device comprising at least one processor, and a memory storing instructions which when executed by the at least one processor configure the processor to receive from an upstream transmitter device at least two partial data streams of packets of an original data stream, and consolidate the at least two partial data streams based on the sequence numbers of the original data stream to reconstruct the original data stream. Each of the at least two partial data streams has an identifier in a header. The at least two partial data streams maintain sequence numbers of the original data stream.

In accordance with another embodiment, there provided a computer-implemented method comprising a receiving device receiving from an upstream transmitter device at least two partial data streams of packets of an original data stream, and consolidating, at the receiving device, the at least two partial data streams based on the sequence numbers of the original data stream to reconstruct the original data stream. Each of the at least two partial data streams has an identifier in a header. The at least two partial data streams maintain sequence numbers of the original data stream.

In accordance with another embodiment, there provided a non-transitory computer readable storage medium with executable instructions which when executed by at least one processor causing the at least one processor to segment data packets of an original data stream into at least two partial data streams. Each of the at least two partial data streams has an identifier in a header. The at least two partial data streams maintain sequence numbers of the original data stream. The at least two partial data streams can be consolidated based on the sequence numbers of the original data stream to reconstruct the original data stream.

In accordance with another embodiment, there provided a non-transitory computer readable storage medium with executable instructions which when executed by at least one processor causing the at least one processor to consolidate at least two partial data streams data packets based on sequence numbers of an original data stream to reconstruct the original data stream. Each of the at least two partial data streams has an identifier in a header. The at least two partial data streams maintain the sequence numbers of the original data stream. The at least two partial data streams were segmented from the original data stream.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 is a diagram of partitioning and reconstruction of an RTP stream according to some embodiments;

FIG. 2 is a schematic diagram of an example segmentation and reconstruction platform according to some embodiments;

FIG. 3 illustrates, in a flowchart, an example of a method of segmenting and sending a data stream, in accordance with some embodiments;

FIG. 4 illustrates, in a flowchart, an example of a method of reconstructing an original data stream, in accordance with some embodiments;

FIG. 5 is a diagram of partitioning and reconstruction of an RTP stream according to some embodiments;

FIG. 6 illustrates, in a flowchart, an example of a method of segmenting and transmitting data streams, in accordance with some embodiments;

FIG. 7 illustrates in a flow diagram an example process of a segmentation and reconstruction platform, in accordance with some embodiments;

FIG. 8 illustrates, in a flowchart, an example of a method of reconstructing an original data stream, in accordance with some embodiments; and

FIG. 9 is a schematic diagram of a computing device such as a server.

It is understood that throughout the description and figures, like features are identified by like reference numerals.

### DETAILED DESCRIPTION

Embodiments of methods, systems, and apparatus are described through reference to the drawings.

RTP can be used to deliver audio and video over IP networks. There are cases, particularly in ultra-high-definition television (UHD) production, where the required bit-rate of an RTP stream is larger than the available capacity of the individual network links available to carry it. Systems used in production can have more than one link available. For example, multiple lower-rate links are available, for example 2×10 Gbe links may be available but not 1×25 Gbe link required to handle the 12 Gbe UHD RTP Stream.

There is currently no generalized way to divide the RTP stream across multiple links. Most “link-aggregation” methods can rely on header hashing which can steer each RTP stream down one link in a link-aggregation group, oversubscribing that link while not utilizing the others. Some methods can be implemented at the content level, which can involve dividing the image into sub-regions for separate transport, for example.

Embodiments described herein related to systems and processes for generalized real-time transport protocol stream segmentation and reconstruction. The systems and processes can be generalized for any RTP payload and can be more compatible with the existing RTP and image standards, including potential compatibility with existing receiver and sender architectures. The systems and processes can have an added feature which is dynamic utilization of the available network links to avoid congestion or oversubscription.

Embodiments will be described herein using RTP as an example protocol used or handled by these embodiments. However, it will be understood that other protocols, including those with a similar sequence numbering method, could also be used or handled by these embodiments, for example, for segmentation and reassembly as described herein. There are many RTP payload definitions for different media types, so systems and processes described herein in relation to RTP can provide many technical advantages.

It should be noted that while some of the teachings herein are described with reference to RTP, other transmission protocols may benefit from the teachings described herein.

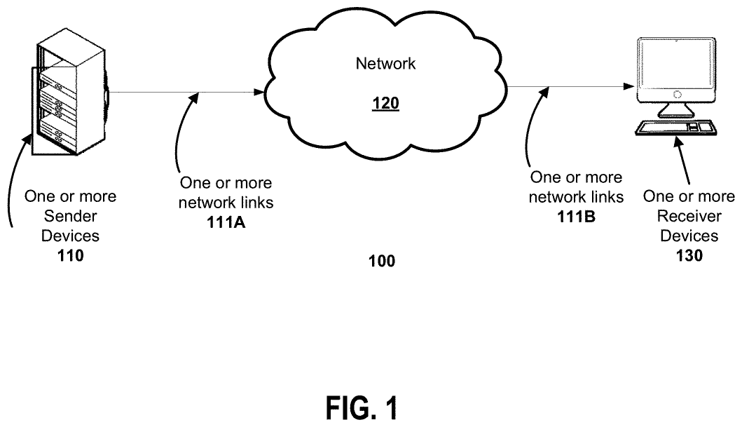

FIG. 1 illustrates an example of a schematic diagram of an example sender device 110 of a segmentation and reconstruction platform 100, in accordance with some embodiments. As shown, the sender device 110 can receive high bandwidth data streams (e.g., RTP streams), perform segmentation on one or more groups of packets or portions of the stream (e.g., based on one or more characteristics that may affect efficiency, transmission, speed, or other network attribute), and distribute one or more groups of packets or portions of the stream (e.g., network partial streams) over one or more links or aggregated links and over one or more networks 120. A computing entity (e.g., receiver device 130) can receive the one or more network partial streams (e.g., packets, groups of packets) and reconstruct the original data stream (e.g., RTP stream) or portion thereof.

In some embodiments, sender device 110 (e.g., transmitter 110) can be a router and receiver device 130 can be a server. In some embodiments, sender device 110 and/or receiver device 130 can each transmit or receive, as appropriate, according to some embodiments.

In some embodiments, network links can be included in one or more transmitter devices 110 and/or in one or more receiver devices 130, and network 120 can include one or more devices or nodes that can be traversed by data (e.g., packets or network partial streams). Data can be routed through network 120 and the route may be different for each network link.

In some embodiments, a sender device 110 and a receiver device 130 can be implemented on separate processing devices, for example, over a distributed network. In some embodiments, implementation for sender devices 110 and receiver devices 130 is separate.

In some embodiments, there can be more than one network interface, for example, as shown by one or more network links 111A and 111B. Each network interface can connect either a sender device 110 to network 120 or a receiver device 130 to network 120, for example. In some embodiments, there can be a plurality of network interfaces.

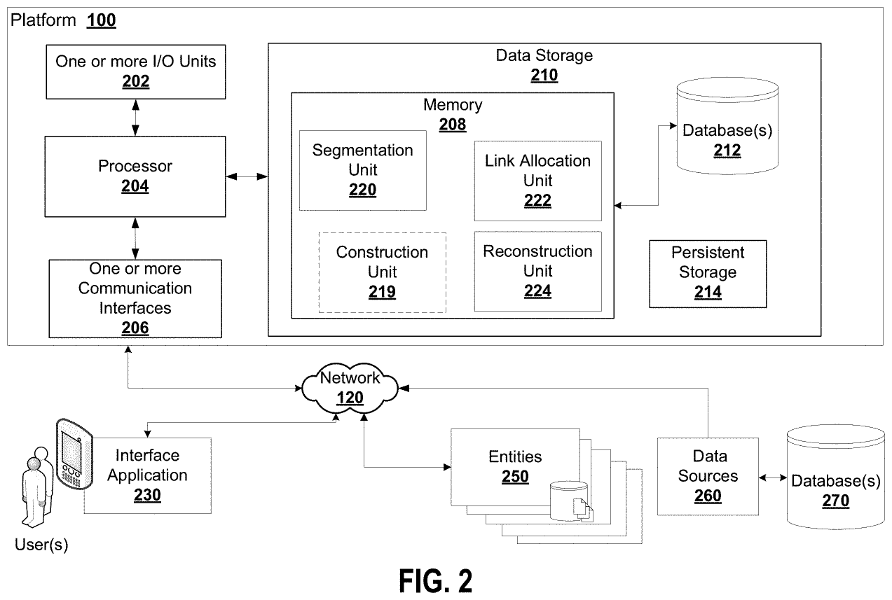

FIG. 2 illustrates in a schematic diagram, an example segmentation and reconstruction platform 100, in accordance with some embodiments, which can be referred to as platform 100. The platform 100 is configured to construct an original stream (e.g., RTP stream) using a desired payload format specification or receive an original RTP stream that have been constructed by another device or platform.

The platform 100 can include one or more I/O Units 202, processors 204, communication interfaces 206, and data storages 210. A processor 204 can execute instructions in memory 108 to implement aspects of processes described herein. The one or more processors 204 can execute instructions in memory 208 to configure segmentation unit 220, link allocation unit 222, reconstruction unit 224, and other functions described herein. Processors 204 can execute instructions in memory 208 to configure reconstruction unit 224, and other functions described herein. For embodiments that involve construction of the original RTP stream, the one or more processors 204 can configure construction unit 219.

In some embodiments, platform 100 is configured to split a signal up over more than one interface. In some embodiments, one or more I/O units 202 and/or communication interfaces 206 can each be integrated with one or more (e.g., a plurality) of links. In some embodiments, many inputs (e.g., plurality of links) can result in a single reconstituted stream of output over a single link or, in some cases, over multiple links.

As an example according to some embodiments, a sender 110 can be configured to receive a single stream (or link) and its one or more processors can be configured to create multiple RTP flows, which can be transmitted over a plurality of links. A receiver 130 integrated with a plurality of links can receive one or more flows or data over the plurality of links and reconstitute same (e.g., into an original stream) into a single stream (or link).

In some embodiments, processor 204 is one or more separate processors, for example, where one or more of construction unit 219, segmentation unit 220, and link allocation unit 222 are configured by one processor (or set of processors that can be distributed, for example) and reconstruction unit 224 (or other functional units) is configured by a separate processor (or set of processors). The processors can be distributed or separated over a network. In some embodiments, a first processor 204 is configured to transmit one or more partial network streams (e.g., packets or groups of packets) over one or more links 220 (e.g., links or aggregated links) over a network to a second processor 204, which is configured to receive same and configure reconstruction unit 224 to reconstruct one or more partial network streams (e.g., packets) into an original network stream or portion thereof (e.g., that the first processor 204 had performed segmentation on).

In some embodiments, the construction unit 219 is optional and configured to construct an original data stream (e.g., RTP stream) using a desired payload format specification. In some embodiments, the platform 100 may receive the original data stream (e.g., RTP stream) using a format specification that is known or provided to the platform 100. In some embodiments, the construction unit 219 creates the original signal internally and then segmenting the signal into network partial streams. In other embodiments, the construction unit 219 may translate a network stream created by other means into a set of network partial streams. The construction unit 219 may comprise a signal formatter or a stream assembly engine.

In some embodiments, the segmentation unit 220 is configured to partition (e.g., segment) packets (or groups of packets) of an original data stream into one or more partial streams (e.g., network partial streams). The segmentation unit 220 is configured to assign, configure, update, compute, and/or generate an updated data indicator associated with each of one or more packets. This data indicator can act as a differentiating detail for each of the packets. For example, the differentiating detail can be contained in a packet's IP header (or other data associated with one or more packets or groups of packets). As an example, segmentation unit 220 can assign a sequence number to each packet that corresponds to the packet's sequence in the original data stream. In this way, the original data stream sequence numbers can be maintained through this process.

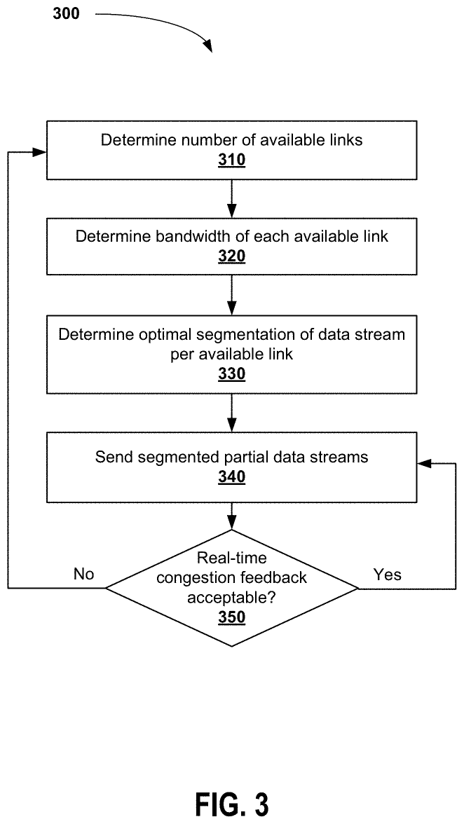

FIG. 3 illustrates, in a flowchart, an example of a method of segmenting and sending a data stream 300, in accordance with some embodiments. The method 300 comprises determining 310 a number of available links. Next, the bandwidth for each available link is determined 320. Next, an optimal segmentation of the original data stream into partial data streams (e.g., optimal allocation pattern of the packets into the network partial streams) is determined 330 based on the number of available links and their respective bandwidth. Next, the segmented partial data streams are sent 340 over the network links. During transmission of the partial data streams, network congestion is monitored. If real-time congestion feedback is acceptable 350, then the partial data steams continue to transmit 340. If real-time congestion feedback is not acceptable 350, then steps 310 to 340 are repeated to determine and/or update the optimal segmentation of the remaining original data stream and to send the resulting updated partial data streams. Network congestion will continue to be monitored 350 until the entire original data stream is sent.

Other steps may be added to the method 300, including determining error characteristics of each link and factoring the error characteristics when determining the optimal segmentation and network link selection. From time to time, new information about the network links may become available (e.g., new links are available, existing links are no longer available, the bandwidth of links has changed, and/or error performance of a link may be updated). When new information becomes available, the segmentation unit 220 may use the new information to optimize the allocation pattern of the packets into the network partial streams. It should be noted that the receiving device 130 is not required to know the means of segmentation which may have been employed by the sender 110.

In some embodiments, segmentation unit 220 may be configured with different methods of separation or segmentation. Packets (e.g., network partial streams) can be selected each for a different network link (e.g., grouped into different network partial streams) based on different methods. Various alternatives can be used. As examples, packets can be selected based on a number of criteria, including, but not limited to, packet selection based on fair loading across available network links; packet selection based on available bandwidth across the available network links; packet selection and duplication based on creating redundant source packets and distributed across diverse network links; round robin across available network links (this may be advantageous, for example, due to simplicity and/or efficiency of implementation or use); based on an RTP Marker (M) bit (e.g., where one frame (all the packets until the next marker bit) goes to link one, next frame goes to link two, and so on); and/or a combination of these or other alternatives.

Still other methods can be used by segmentation unit 220, for example, methods that can also be convenient to implement. For example, segmentation unit 220 may be configured to scan line together in one stream for example, next scan line in the next stream; or make a protected set of three or more streams where each packet appears in two of the streams, so the loss of any one stream may be tolerated provided the other streams are received. In this way, in these embodiments, segmentation unit 220 can be configured to provide packet redundancy to reduce packet loss and improve reconstruction and viability of a data stream.

In some embodiments, platform 100 provides technical benefits by splitting a source stream (e.g., RTP stream) into network partial streams.

In some embodiments, the link allocation unit 222 is configured to assign and/or manage the paths (e.g., egress interface, link(s), aggregated link(s), portions of one or more networks) that each network partial stream of an original data stream (e.g., original RTP stream) takes, for example, over a network from a sender to a receiver. Link allocation unit 222 may be integrated with segmentation unit 220. For example, in some embodiments, the path assigned to a network partial stream is based on a data detail (e.g., a differentiating detail) in a header of one or more packets (including groups of packets or a network partial stream). These data details can be updated or generated by segmentation unit 220 or link allocation unit 222 and more than one network partial stream may have the same or different data details.

In some embodiments, the link allocation unit 222 is configured to dynamically modify the creation of network partial streams, the generation and/or assignment of data details (e.g., associated with a packet, group of packets, or network partial stream), assignment of which path(s) (e.g., network links) or network node(s) a network partial stream (e.g., packet or group of packets) takes, and/or segmentation of one or more packets (e.g., from an original data stream) into network partial streams. In this way, link allocation unit 222 is configured, in these embodiments, to balance network load across multiple links. In some embodiments, the partial data streams are based on user settings. In some embodiments, the partial data streams are based on information received regarding available bandwidth and error characteristics of each link.

As an example, packet assignment (e.g., the relationship between selection and path) can be based on the previously mentioned selection criteria and performed by segmentation unit 220. Packets that are to be distributed fairly across, for example, four available links can be selected from the source based on the relationship between the source bitrate and the bandwidth of the available links. Link allocation unit 222 can be configured to assess these criteria and perform this distribution.

For example, if at a source there is a 25 Mb stream, available links are five, and each link is capable of 10 Mb but no more, link allocation unit 222 can be configured to select packets from the source stream such that 1:5 packets are distributed to each target network link resulting in 5×5 Mb links. This is an example fair loading method. In some embodiments, link allocation unit 222 is configured to implement other methods, for example, where the distribution of source packets to network links is based on requirements driven by actual available bandwidth on the destination network links, any resiliency scheme that is desired, other target utilization of the links that may be required or beneficial, and/or other characteristic of packets or networks.

In some cases, the paths through a network 120 can be subject to or influenced by the network's 120 routing rules and flow management policies and tools. Bandwidth constraints can be exhibited (in some cases, most prominently) at the ingress or egress connections between the equipment and the first switch, but there can also be aggregated links (made of several smaller tributaries) at intermediate points in the network. Bandwidth constraints at these locations may impede transmission of packets (including RTP network partial streams). In some embodiments, link allocation unit 222 is configured to implement flow planning that can pick a path for the stream based on planning its bandwidth. In this case, link allocation unit 222 can manage the network 120 to route several small streams instead of one large stream, which can far more routing possibilities. In some embodiments, link allocation unit 222 is configured to select one or more paths for one or more packets or streams based on assessment of a network's 120 routing rules and flow management policies and tools. In some embodiments, link allocation unit 222 is configured to select one or more paths for one or more packets or streams based on a combination of one or more factors described herein.

In some embodiments, link allocation unit 222 is configured to modify creation of network partial streams dynamically based on network load. For example, link allocation unit 122 can redirect certain streams (or packets) to different links that are less congested and based on the usage patterns of the network. Link allocation unit 222 is configured to receive data indicators representing one or more characteristics of a network 120, including usage patterns, capacity, load, efficiency, packet loss, bandwidth, and/or other characteristic. Each of these characteristics can be received or transmitted in real-time, near real-time, or timely manner, for example, where the characteristics change (e.g., during use/transmission of data), and/or at a different time before, after, or during the characteristic is actually manifest.

For instance, in a fully managed network 120, it may be known ahead of time that a certain available network link will receive new (third party) traffic, lowering available bandwidth. In some embodiments, in this instance, link allocation unit 222 is configured to proactively map selected packets to network links and available bandwidth based on the known, changing dynamics of the network. Other methods can include reacting to derived network congestion. For example, the receiver is configured to recognize that a particular network link is suffering from congestion based on inter-packet delay measurements and request that the sender change the mapping scheme accordingly.

In some embodiments, congestion in the receiver (Rx) 130 could be determined based on the packet delay or packet delay variation.

To do this dynamically, in some embodiments, link allocation unit 222 is configured to implement control system feedback—either through layer-2 tools like Explicit Congestion Notification, or through some more explicit application-layer control interaction. The sender can know the congestion of its own egress ports, which is often the main source of congestion, so the act of fitting the streams into the sender's own egress interfaces is the first bit of dynamic allocation performed by link allocation unit 222. The technique can be implemented by link allocation unit 222 can be useful even if there is no dynamic element—partitioning the original stream fairly across the network streams can solve many use cases.

In some embodiments, therefore, link allocation might not be dynamic. In some embodiments, link allocation is dynamic. A variety of other methods can be used to effect dynamic link allocation, selection of which packets to rearrange, and/or dynamic reallocation of segmentation.

In some embodiments, the reconstruction unit 224 (e.g., at a downstream RTP receiver) is configured to receive one or more packets over a network 120. For example, network partial streams can be received over different ingress interfaces and reconstruction unit 224 is configured to consolidate packets received from each interface, ordering them based on differentiating data indicators (e.g., RTP sequence numbers). In this way, reconstruction unit 224 is configured to reconstruct the original RTP stream. Reconstruction unit 224 may implement reconstruction in a variety of ways and based on one or more different data indicators or characteristics.

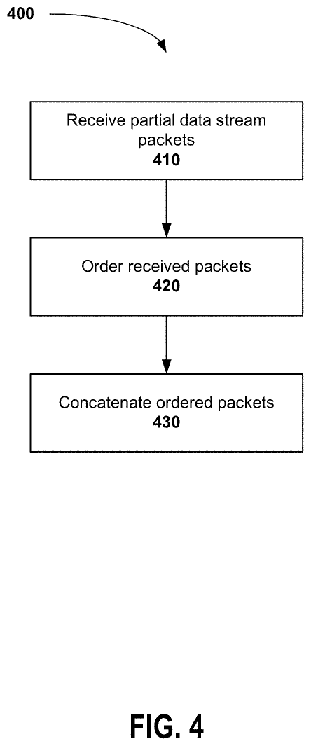

FIG. 4 illustrates, in a flowchart, an example of a method of reconstructing an original data stream 400, in accordance with some embodiments. The method 400 comprises receiving 410 partial data stream packets. Next, all packets are ordered 420 based on an indication (e.g., a sequence number). Next, the ordered packets are concatenated 430 to form the original data stream. Other steps may be added to the method 400.

The platform 100 connects to interface application 230, entities 250, and data sources 260 (with databases 270) using network 120. Network 120 (or multiple networks) is capable of carrying data and can involve wired connections, wireless connections, or a combination thereof. Network 120 may involve different network communication technologies, standards and protocols, for example.

The I/O unit 202 can enable the platform 100 to interconnect with one or more input devices, such as a keyboard, mouse, camera, touch screen and a microphone, and/or with one or more output devices such as a display screen and a speaker.

The processor 204 can be, for example, a type of general-purpose microprocessor or microcontroller, a digital signal processing (DSP) processor, an integrated circuit, a field programmable gate array (FPGA), a reconfigurable processor, or a combination thereof.

Memory 208 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 210 can include memory 208, databases 212 (e.g., graph database), and persistent storage 214.

The communication interface 206 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 can connect to different machines or entities 250.

In some embodiments, the platform 100 is implemented at both the sender network/device 110 and the receiver network/device 130. In this way, an end-to-end solution is provided between the sender device 110 and receiver device 130. Thus, the platform 100 is not limited to resolving congestion between two adjacent switches, but may be used to resolve congestion across the entire network 120 by selecting different network links (e.g., paths) to send the data stream, e.g., including segmenting the data stream into groupings of packets based on the size and/or congestion of a network link to be used.

In some embodiments, the platform 100 is configured to segment the data stream at the end devices 110, 130. This allows for the platform and methods described herein to operate across different networks, different network types (e.g., Ethernet, wireless 4G, wireless 5G, etc.), handle local congestion on one of the hops in the network, react (dynamic congestion avoidance) as quickly as needed by the application (to prevent latency). A non end-to-end solution that is performed by the network may be slow for the application as such an implementation may need to know both global and discrete knowledge across the whole network. It should be noted that the platform may be implemented and operated by any two points in a network (i.e., not only the end points of a sender device 110 and a receiver device 130). For example, gateways within a large network may implement the platform 110 as a service.

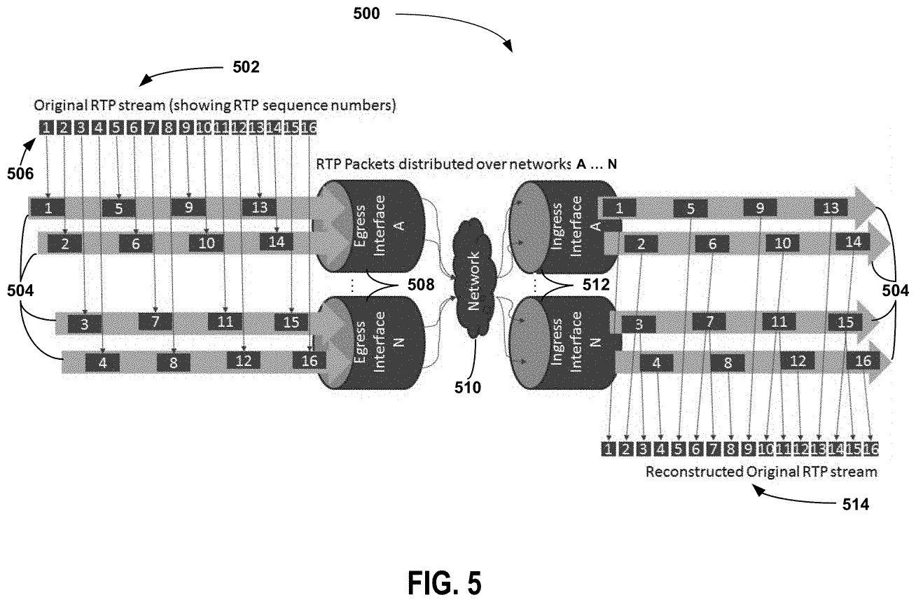

FIG. 5 illustrates in a diagram an example of partitioning and reconstruction 500 of an RTP stream, in accordance with some embodiments. As shown, in this example, packets are partitioned according to a symmetrical 1/2/3/4 partitioning. This is an example and other partitioning techniques can be used. In some embodiments, a different partitioning function can be used that can be more complex and split packets or portions of a stream (e.g., network partial stream) across any number of network links using an asymmetrical distribution of packets.

As shown, an original RTP stream 502 (e.g., an original data stream) can be segmented by segmentation unit 220 into a plurality of network streams 504 (e.g., at least two partial data streams). The original RTP stream 502 has RTP sequence numbers 506. The partitioned network streams 504 can also indicate the RTP sequence numbers 506. The network streams 504 may be differentiated based on source UDP port, destination UDP port, destination IP address, source IP address, and/or combinations of same. Segmentation unit 220 can be segmented by different methods (e.g., symmetrical 1/2/3/4, etc.) or a combination of same. The partitioned network streams 504 can be distributed across egress interfaces 508 (e.g., egress interface A . . . egress interface N). The egress interfaces 508 can distribute the RTP packets (e.g., of the partitioned network streams 504) over networks A . . . N 510 which can involve network links. The networks (e.g., networks A . . . N) 510 can provide the RTP packets to ingress interfaces 512 (ingress interface A . . . ingress interface N). The reconstruction unit 224 can reconstruct the original RTP stream 502 from the RTP packets of the partitioned network streams 504. The reconstruction unit 224 can use the RTP sequence numbers 506 indicated by the RTP packets of the partitioned network streams 504 so that the reconstructed RTP stream 514 maintains the RTP sequence numbers 506.

In some embodiments, there is provided a network device for generalized real-time transport protocol (RTP) stream segmentation and reconstruction. The device configured to segment RTP packets of an original RTP stream into a plurality of network partial streams. Each of the plurality of network partial streams has an identifier in a header (such as an IP header). For example, the identifier may involve an RTP sequence number. The plurality of network partial streams maintain sequence numbers of the original RTP stream. The device can implement segmentation unit 220, for example. The device is configured to transmit the plurality of network partial streams to a downstream receiver. The downstream receiver can be configured to consolidate the plurality of network partial streams based on the sequence numbers of the original RTP stream to reconstruct the original RTP stream. In some examples, the downstream receiver can implement reconstruction unit 224. The reconstructed original RTP stream maintains sequence numbers of the original RTP stream. The device can involve different computing components, links and interfaces. RTP is an example network protocol. In some embodiments, the stream can use a different transport protocol. In some embodiments, segmentation is configured based on one or more characteristics of a network, for example, bandwidth or usage of a network link. This can provide an advantage to minimize or avoid congestion or oversubscription, thereby improving transmission efficiency, quality, and/or speed.

As shown, different packets can be segmented or partitioned into different network streams and each be transmitted through different egress interfaces (e.g., egress interface A . . . egress interface N) and subsequently over a network 120. Groups of packets (e.g., a network partial stream) may be transmitted over different links over a network and may arrive at different ingress interfaces (e.g., B versus M). Reconstruction unit 224 is configured to reconstruct an original stream (e.g., original RTP stream or portion thereof) from packets or network partial streams received. The received packets or streams may be through different ingress interfaces. In some cases, packets or streams or portions of same may be lost during transmission, but segmentation by segmentation unit 220 and/or reconstruction by reconstruction unit 224 is configured to manage such loss (e.g., provide a suitable reconstructed stream due to packet redundancy and segmentation).

In some embodiments, there is provided dynamic reallocate the network segmentation scheme in order to optimize delivery of the network streams.

Without platform 100, RTP streams may not be divided across different links. Due to increase in resolution and the utilization of RTP, technical problems are encountered, e.g., with transmission and efficiency and load allocation. Further, content may be lost.

In some embodiments, the systems and methods described herein may work with any sequenced RTP stream, which can include many of the RTP streams in use worldwide. As 4K/UHD production increases, these streams are becoming very high bit-rate, so the need arises to split them up. In some embodiments, a picture can be split up into regions or stripes and send each of those as a separate sub-image in a separate stream, but this may become an application-specific implementation. In some embodiments, systems and methods described herein may instead take the RTP stream representing the whole image and segments it at the packet level into multiple network streams which can be re-assembled simply based on sequence number and applied to the already-documented RTP reassembly process.

In some embodiments, systems and methods described herein can assess which network links are available in the following manner. For example, there may be known networks where the networks themselves are tightly managed. The sender is aware of the availability and the loading level on its own egress interfaces; beyond that, the flows may be planned and managed in the network (if it is a flow-managed network). In some embodiments, platform 100 may utilize this method on ‘wild’ networks simply by querying the local system for port availability. That same or similar query can also poll the system for current network utilization.

In some embodiments, platform 100 can continuously assess the level of usage of links and select one or more according to their respective usage. A variety of characteristics may determine which links are selected for which partial streams. For example, incoming packets are monitored by a receiver as described herein and it can inform the sender of changes in link quality.

In some embodiments, platform 100 is compatible with a variety of protocols, networks, and transmission mechanisms. In some embodiments, platform 100 does not divide transmission at content level.

In some embodiments, platform 100 provides advantages over methods that instead divide transmission at the content level such as being compatible with existing solutions and standards, simplifies the transmitter and receiver, working with any image resolution or bit-depth, dynamically changing partial streams, and does not require decoding the content. This allows it to used other applications, e.g., not just uncompressed video.

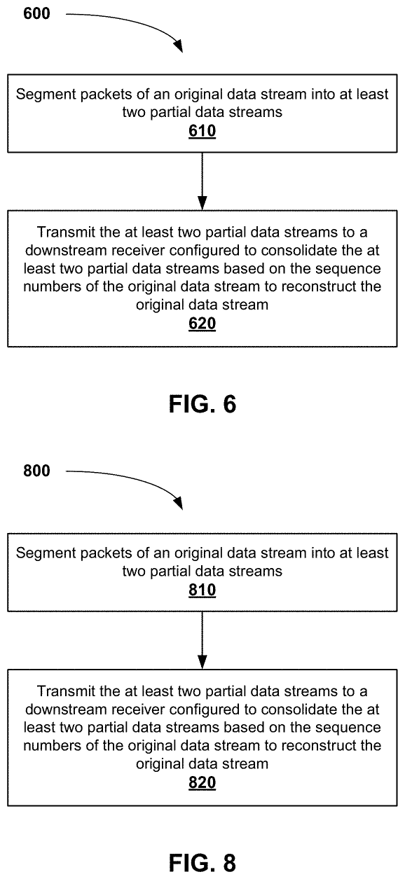

FIG. 6 illustrates, in a flowchart, an example of a method of segmenting and transmitting data streams 600, in accordance with some embodiments. The method 600 comprises segmenting 610, by at least one processor, packets of an original data stream into at least two partial data streams. Each of the at least two partial data streams includes an identifier in an Internet protocol (IP) header. The at least two partial data streams maintain sequence numbers of the original data stream. Once the packets are segmented 610, they are then transmitted 620, by the at least one processor, to a downstream receiver configured to consolidate the at least two partial data streams based on the sequence numbers of the original data stream to reconstruct the original data stream. Other steps may be added to the method 600.

In some embodiments, the original data stream comprises a real-time transport protocol (RTP) stream.

In some embodiments, the method 600 comprises differentiating, by at least one processor, the partial streams by at least one of a source port, a destination port, a source address, a destination address, or a combination thereof.

In some embodiments, the method 600 comprises segmenting, by at least one processor, the packets following at least one segmentation method.

In some embodiments, the at least one segmentation method 600 comprises one of packet selection based on fair loading across available network links, packet selection and duplication based on creating redundant source packets and distributed across diverse network links, sending packets across available network links in a round robin manner, or packet selection based on bit markers of frames of packets.

In some embodiments, the method 600 comprises dynamically reallocating, by at least one processor, at least one network link to optimize delivery of the at least two partial streams. In some embodiments, to dynamically reallocate the at least one network link comprises reallocating packets to one of the at least one network link based on at least one of data detail in the header of at least one packet, fair distribution among the at least one network link, a source bit rate, or a bandwidth of the available network links. In some embodiments, the dynamic reallocation is based on at least one of historical congestion patterns among the available network links, or derived congestion patterns among the available network links via at least one of inter-packet delay measurements, packet loss, or a control system feedback.

In some embodiments, the method 600 comprises at least one of constructing, by at least one processor, the original data stream using a payload format specification, or receiving, by at least one processor, the original data stream.

In some embodiments, the identifier in the IP header provides a differentiating detail for the respective partial stream.

In some embodiments, the method 600 comprises the at least one processor receiving a segmentation configuration option from a sender of the original data stream, and segmenting the original based on the received segmentation configuration option.

In some embodiments, each partial stream follows an egress interface and/or path within a network based on its respective header data, and the method 600 comprises selecting, by at least one processor, the egress interface and/or path for each partial stream using its respective header data.

In some embodiments, the method 600 comprises transmitting, by at least one processor, the at least two partial data streams over different interfaces.

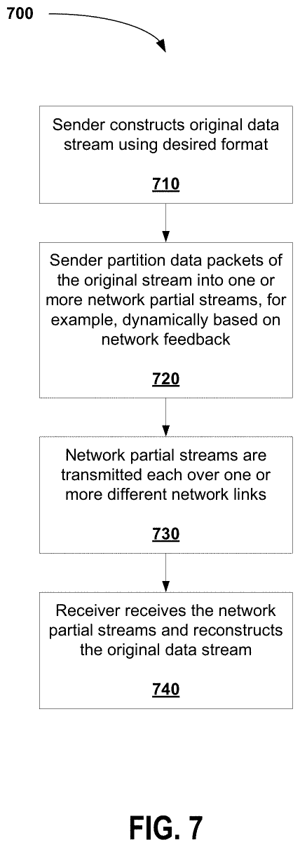

FIG. 7 illustrates in a flow diagram another example process 700 of platform 100, in accordance with some embodiments.

In some embodiments, segmentation and reconstruction platform 100 provides delivery of high bandwidth RTP streams over challenged networks.

At 710, the segmentation and reconstruction platform 100 is configured to construct an original RTP stream using a desired payload format specification (e.g., SMPTE ST 2110-20).

At 720, the segmentation and reconstruction platform 100 (e.g., via segmentation unit 220) is configured to separate the RTP packets of the original RTP stream into a plurality of network partial streams, each with some differentiating detail in the IP header. The original RTP stream sequence numbers are maintained through this process. The method of separation can be chosen by the sender amongst many possibilities. Each network partial stream may take a different egress interface and/or take a different path within the network based on its header details.

At 730, link allocation unit 222 is configured to arrange transmission of network partial streams over one or more different network links, for example, based on network congestion or link availability or bandwidth or another characteristic associated with a link or a packet or group of packets.

At 740, a downstream RTP receiver receives all of the network partial streams, perhaps receiving them over different ingress interfaces, and consolidates the packets from each, ordering them based on the RTP sequence numbers, thereby reconstructing the original RTP stream.

Where arrival times of packets can be affected by competing network traffic or where the network may experience packet loss due to congestion the scheme of creating network partial streams can be modified on the fly to rebalance the network load.

FIG. 8 illustrates, in a flowchart, an example of a method of reconstructing an original data stream 800, in accordance with some embodiments. The method 800 comprises receiving 810, at a receiving device from an upstream transmitter device, at least two partial data streams of packets of an original data stream. Each of the at least two partial data streams having an identifier in an Internet protocol (IP) header. The at least two partial data streams maintain sequence numbers of the original data stream. Once received 810, the at least two partial data streams are consolidated 820 based on the sequence numbers of the original data stream to reconstruct the original data stream. Other steps may be added to the method 800, including consolidating the at least two partial data streams by ordering real-time transport protocol (RTP) packets using the sequence numbers to reconstruct an original RTP stream, and receiving the at least two partial data streams over different ingress interfaces.

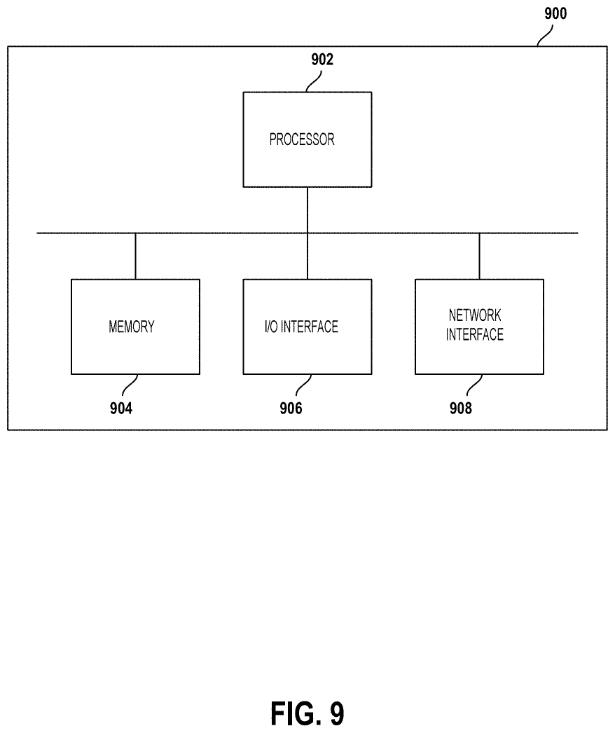

FIG. 9 is a schematic diagram of a computing device 900 such as a server. As depicted, the computing device includes at least one processor 902, memory 904, at least one I/O interface 906, and at least one network interface 908.

Processor 902 may be an Intel or AMD x86 or x64, PowerPC, ARM processor, or the like. Memory 904 may include a suitable combination of computer memory that is located either internally or externally such as, for example, random-access memory (RAM), read-only memory (ROM), compact disc read-only memory (CDROM).

Each I/O interface 906 enables computing device 900 to interconnect with one or more input devices, such as a keyboard, mouse, camera, touch screen and a microphone, or with one or more output devices such as a display screen and a speaker.

Each network interface 908 enables computing device 900 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others.

In accordance with one aspect, there is provided a network device for generalized real-time transport protocol (RTP) stream segmentation and reconstruction. The device can be configured to segment RTP packets of an original RTP stream into a plurality of network partial streams, each of the plurality of network partial streams having an identifier in an IP header, the plurality of network partial streams maintaining sequence numbers of the original RTP stream. The device can be configured to transmit the plurality of network partial streams to a downstream receiver. The downstream receiver can be configured to consolidate the plurality of network partial streams based on the sequence numbers of the original RTP stream to reconstruct the original RTP stream.

In some embodiments, the device (e.g., sending device) is configured to differentiate the network streams by one or more of source port, destination port, source address, destination address, or a combination thereof.

In some embodiments, the device (e.g., sending device) is configured to segment the RTP packets using different segmentation methods.

In some embodiments, the device (e.g., sending device) is configured to dynamically reallocate a network segmentation configuration to optimize delivery of the plurality of network partial streams.

In some embodiments, the device (e.g., sending device) is configured to construct the original RTP stream using a payload format specification.

In some embodiments, the identifier in the IP header provides a differentiating detail for the respective network partial stream.

In some embodiments, the device (e.g., sending device) is configured to maintain the original RTP stream sequence through the segmentation, transmission and reconstruction.

In some embodiments, maintaining the original sequence numbering can be critical to reassembly.

In some embodiments, the device (e.g., receiving device) is configured to receive a segmentation configuration option from a sender of the original RTP stream and segment based on the segmentation configuration option.

In some embodiments, each network partial stream can take an egress interface and/or path within a network based on its respective header data. The device is configured to transmit the partial streams to different egress interfaces or paths.

In some embodiments, the downstream receiver (e.g., receiving device) is configured to consolidate the plurality of network partial streams by ordering RTP packets using the sequence numbers to reconstruct the original RTP stream.

In some embodiments, the device (e.g., sending device) is configured to transmit the plurality of network partial streams over different interfaces.

In some embodiments, the downstream receiver (e.g., receiving device) is configured to receive the plurality of network partial streams over different ingress interfaces.

In accordance with another aspect, there is provided a non-transitory computer readable storage medium with executable instructions for causing a processor to segment

RTP packets of an original RTP stream into a plurality of network partial streams, each of the plurality of network partial streams having an identifier in an IP header, the plurality of network partial streams maintaining sequence numbers of the original RTP stream. The plurality of network partial streams can be consolidated based on the sequence numbers of the original RTP stream to reconstruct the original RTP stream.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A network device comprising:
at least one processor; and
a memory storing instructions which when executed by the at least one processor configure the processor to:
segment packets of an original data stream into at least two partial data streams, each of the at least two partial data streams having an identifier in an Internet protocol (IP) header, the at least two partial data streams maintaining sequence numbers of the original data stream; and
transmit the at least two partial data streams to a downstream receiver configured to consolidate the at least two partial data streams based on the sequence numbers of the original data stream to reconstruct the original data stream.

2. The network devised as claimed in claim 1, wherein the at least one processor is configured to:
differentiate the partial streams by at least one of a source port, a destination port, a source address, a destination address, or a combination thereof.

3. The network device as claimed in claim 1, wherein the at least one processor is configured to:
segment the packets following at least one segmentation method comprising one of:
packet selection packets based on fair loading across available network links;
packet selection and duplication based on creating redundant source packets and distributed across diverse network links;
sending packets across available network links in a round robin manner; or
packet selection based on bit markers of frames of packets.

4. The network device as claimed in claim 1, wherein the at least one processor is configure to:
dynamically reallocate at least one network link to optimize delivery of the at least two partial streams, comprising reallocate packets to one of the at least one network link based on at least one of:
data detail in the header of at least one packet;
fair distribution among the at least one network link;
a source bit rate;
a bandwidth of the available network links;
historical congestion patterns among the available network links; or
derived congestion patterns among the available network links via at least one of:
inter-packet delay measurements; or
a control system feedback.

5. The network device as claimed in claim 1, wherein the at least one processor is configured to at least one of:
construct the original data stream using a payload format specification; or
receive the original data stream.

6. The network device as claimed in claim 1, wherein the identifier in the IP header provides a differentiating detail for the respective partial stream.

7. The network device as claimed in claim 1, wherein the at least one processor is configured to:
receive a segmentation configuration option from a sender of the original data stream; and
segment the original based on the received segmentation configuration option.

8. The network device as claimed in claim 1, wherein:
each partial stream follows an egress interface and/or path within a network based on its respective header data; and
the at least one processor is configured to select the egress interface and/or path for each partial stream using its respective header data.

9. A computer-implemented method comprising:
segmenting, by at least one processor, packets of an original data stream into at least two partial data streams, each of the at least two partial data streams having an identifier in an Internet protocol (IP) header, the at least two partial data streams maintaining sequence numbers of the original data stream; and
transmitting, by the at least one processor, the at least two partial data streams to a downstream receiver configured to consolidate the at least two partial data streams based on the sequence numbers of the original data stream to reconstruct the original data stream.

10. The method as claimed in claim 9, comprising:
differentiating, by at least one processor, the partial streams by at least one of a source port, a destination port, a source address, a destination address, or a combination thereof.

11. The method as claimed in claim 9, comprising:
segmenting, by at least one processor, the packets following at least one segmentation method comprising one of:
packet selection packets based on fair loading across available network links;
packet selection and duplication based on creating redundant source packets and distributed across diverse network links;
sending packets across available network links in a round robin manner; or
packet selection based on bit markers of frames of packets.

12. The method as claimed in claim 9, comprising:
dynamically reallocating, by at least one processor, at least one network link to optimize delivery of the at least two partial streams, comprising reallocating packets to one of the at least one network link based on at least one of:
data detail in the header of at least one packet;
fair distribution among the at least one network link;
a source bit rate;
a bandwidth of the available network links;
historical congestion patterns among the available network links; or
derived congestion patterns among the available network links via at least one of:
inter-packet delay measurements; or
a control system feedback.

13. The method as claimed in claim 9, comprising at least one of:
constructing, by at least one processor, the original data stream using a payload format specification; or
receiving, by at least one processor, the original data stream.

14. The method as claimed in claim 9, wherein the identifier in the IP header provides a differentiating detail for the respective partial stream.

15. The method as claimed in claim 9, comprising:
receiving, by at least one processor, a segmentation configuration option from a sender of the original data stream; and
segmenting, by at least one processor, the original based on the received segmentation configuration option.

16. The method as claimed in claim 9, wherein:
each partial stream follows an egress interface and/or path within a network based on its respective header data; and
comprising selecting, by at least one processor, the egress interface and/or path for each partial stream using its respective header data.

17. A network device comprising:
at least one processor; and
a memory storing instructions which when executed by the at least one processor configure the processor to:
receive from an upstream transmitter device at least two partial data streams of packets of an original data stream, each of the at least two partial data streams having an identifier in an Internet protocol (IP) header, the at least two partial data streams maintaining sequence numbers of the original data stream; and
consolidate the at least two partial data streams based on the sequence numbers of the original data stream to reconstruct the original data stream.

18. A computer-implemented method comprising:
receiving, at a receiving device from an upstream transmitter device, at least two partial data streams of packets of an original data stream, each of the at least two partial data streams having an identifier in an Internet protocol (IP) header, the at least two partial data streams maintaining sequence numbers of the original data stream; and
consolidating, at the receiving device, the at least two partial data streams based on the sequence numbers of the original data stream to reconstruct the original data stream.
